(19) United States
(12) Patent Application Publication
(10) Pub. No.: US 2008/0216647 A1
(43) Pub. Date: Sep. 11, 2008

(54) Salon air purification system

(76) Inventor: Trungnhan Phan, Simi Valley, CA (US)

Correspondence Address: Trungnhan Phan, 1550 Rory Lane #217, Simi Valley, CA, 93063, US

(21) Appl. No.: 12/074,948

(22) Filed: Mar. 7, 2008

Related U.S. Application Data
(60) Provisional application No. 60/905,380, filed on Mar. 7, 2007.
(60) Provisional application No. 60/920,272, filed on Mar. 27, 2007.

(51) Int. Cl. B01D 46/46; A47B 37/00; B03C 3/68; B01D 35/31

(52) U.S. Cl. 95/8; 454/66; 108/50.13; 96/19; 55/360; 96/397

(57) ABSTRACT

The method for salon air purifying comprises the following steps: (a) categorizing contaminants generated in the salon; (b) selecting air purifiers such that each air purifier is most effective in capturing a specific category of contaminants; (c) detecting which category of contaminants is being generated; (d) activating the air purifier that would most effectively capture the specific contaminants being generated and deactivate other air purifier(s) if not needed. Applying the aforementioned method, the apparatus for salon air purification comprises: (a) detectors to detect which category of contaminants are being generated, (b) two different air purifiers: one for capturing chemical fumes and the other for capturing filing dust and (c) a controller to receive the detectors' data, to activate air purifier only when airborne contaminants are present and to select which air purifier to activate based on the detectors' data.

### CROSS-REFERENCE TO RELATED APPLICATIONS

The present application claims the benefit of provisional patent application, serial No. 60/905380, filed Mar. 7, 2007, for NAIL SALON AIR PURIFICATION SYSTEM, by Trungnhan Phan.

The present application claims the benefit of provisional patent application, serial No. 60/920272, filed Mar. 27, 2007, for NAIL SALON VENTILATION SYSTEM, by Trungnhan Phan.

### FEDERALLY SPONSORED RESEARCH

Not Applicable

### SEQUENCE LISTING, COMPUTER PROGRAM

Not Applicable

### BACKGROUND OF THE INVENTION

1. Field of the Invention

The present invention relates to the field of salon air purification and more particularly, it relates to the method and apparatus for activating the air purifiers only when the contaminants are being emitted and for activating the most effective purifier for that category of contaminants.

2. Description of Related Arts

The use of air purifiers is known in the prior art. More specifically, air purifiers devised and utilized are known to consist basically of familiar structural configurations with the myriad of designs encompassed by the crowded prior art, which have been developed for the fulfillment of countless objectives and requirements. Examples of these systems are described in the following U.S. Pat. No. 4,852,468, U.S. Pat. No. 53,361,228, U.S. Pat. No. 5,463,029, U.S. Pat. No. 6,471,579, U.S. Pat. No. 6,698,360. While these devices fulfill their respective, particular objectives and requirements, the aforementioned patents focus on optimizing a single filter but do not disclose a new apparatus for independently controlling air-borne particles at a manicure workstation and for activating the air purifiers when contaminants are being emitted and deactivating them afterward.

A full set of nails can take up to one hour or more to complete. Before a sculptured nail can be applied, old color coats are removed and the natural nail surface is filed to created a rougher surface for better adhesion of the new nail. The natural nail surface is then sanitized with isopropanol and an acrylic primer is applied, which also promotes better adhesion. A removable mold or form is then attached to the fingernail, over which the sculptured nail is formed. The sculptured nail is formed entirely with a small brush applicator, which is dipped first into a liquid monomer, then dipped into a powder polymer to form an acrylic mixture bead which is then applied to the fingernails. The nail technician then forms the nail into the general shape before curing (hardening) takes place. Further refined shaping is accomplished by filing after curing. The nail is strengthened with thin fiberglass fabric. Cuticle oil is usually applied, and the nail is buffed. A base coat is applied, followed by one or two color coats and a clear protective coat.

The contaminants in the salons that offer artificial nail services can be classified into two categories, fumes and filing dust. These two types of contaminants have different chemical and physical characteristics, which require different air purifiers to filter them. The fumes are in a gaseous state so the filter needs to be a fine filter, in the range of tenths of micron, to be effective; a standard dust filter would not be effective in removing the above fumes from the air. Alternatively, the dust and debris from filing consist of larger airborne particles, in the range of hundreds of microns, which call for a coarse filter and a stronger suction force to attract the dust to the filter.

If only a fine type of filter (for example 0.3 microns) is used, and this type of filter will quickly get clogged from the filing dust and debris hundreds times larger than the filter pore size. However, the use of a coarser filter would be ineffective in filtering the fumes. A filter that runs on timer may have the room filled with contaminants before its scheduled time to operate.

The present invention departs from the conventional concepts and designs of the prior art, and in so doing provides a method and an apparatus primarily developed for the purpose of independently controlling air-borne particles associated with artificial nail services and fumes associated with other services, and activated the air purifier only when the contaminants are being emitted.

In the present invention, two separate air purifiers are used, one to capture filing dust, and the other to control fumes. These two air purifiers are activated by a control system that detects the sources of the contaminants or the presence of the contaminants themselves. Air filtering effectiveness is enhanced by activating the appropriate air purifier—the fine filter to control fume and the coarse filter or vacuum cleaner to control filing dust.

By activating the air purifier(s) when contaminants are being emitted, the present invention captures the contaminants before they get a chance to disperse in the room. By deactivating the air purifier(s) when contaminants are not being emitted the present invention provides an improvement of energy efficiency and prolonged equipment life.

### BRIEF SUMMARY OF THE INVENTION

The primary object of this invention is to provide a method and an apparatus for salon air purifying. The method for salon air purifying comprises the following steps: (a) categorizing contaminants emitted in the salon; (b) selecting air purifiers such that each air purifier most effectively captures a specific category of contaminants; (c) detecting which category of contaminants is being emitted; (d) activating the air purifier that would most effectively capture the specific contaminants being emitted and deactivate other air purifier(s) if not needed. Applying the aforementioned method, the apparatus for salon air purification comprises: (a) detectors to detect which category of contaminants are being emitted, (b) two different air purifiers: one for capturing fumes and the other for capturing filing dust and (c) a microcontroller 510 to receive the detectors' data, to activate air purifier only when airborne contaminants are present, and to select which air purifier to activate based on the detectors' data.

Other objectives and advantages are as follows:

To provide an apparatus to activate air purifier only when airborne contaminants are being emitted.

To provide an apparatus to indirectly detect that the airborne contaminant are being emitted.

To provide an air purification station comprising two independently operated air purifiers.

To provide apparatus for activating the electric file when it is removed from the base, a cradle.

To provide apparatus for activating the electric power when the electric file is removed from the base.

Additional objectives of the invention, as well as features and advantages, will be explained in the description that follows or may be learned through the use of the invention.

### BRIEF DESCRIPTION OF THE SEVERAL VIEWS OF THE DRAWING

FIG. 1 is a perspective view of an air purification system.

FIG. 2 is a top view of the air purification station with the section line 3-3 defines the cutting plane to generate FIG. 3.

FIG. 3 is a section view of the air purification station.

FIG. 4 is a top view of an electric file detector with the electric file placed on top with the section line 5-5 defines the cutting plane to generate FIG. 5.

FIG. 5 is a section view of the electric file detector with the electric file placed on top.

FIG. 6 is a schematic that illustrates a control circuit for using the electric file detector.

FIG. 7 is a schematic that illustrates a control circuit for using the electric file detector.

FIG. 8 is a schematic that illustrates a control circuit for using the electric file detector.

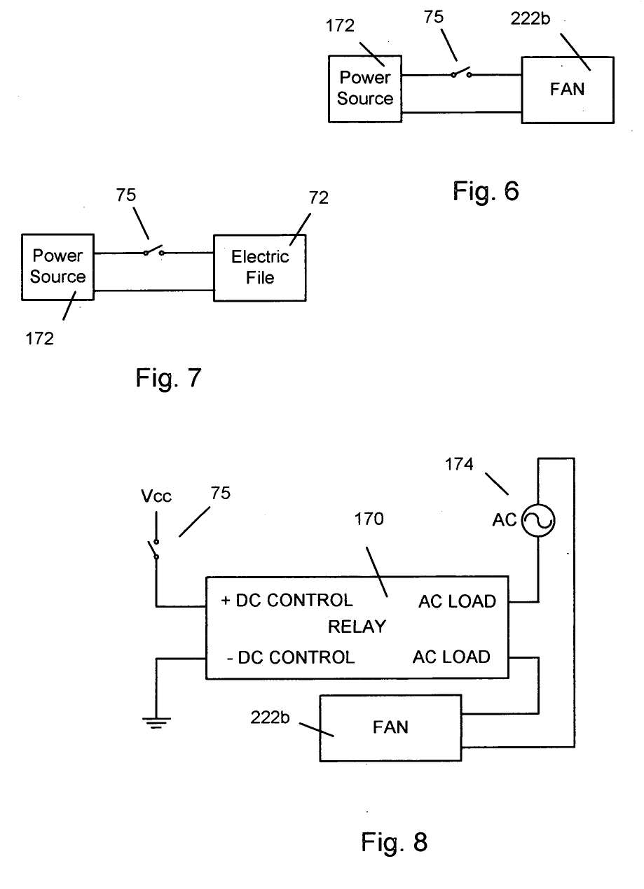

FIG. 6 is a schematic that illustrates a circuit for activating a fan using the electric file detector.

FIG. 7 is a schematic that illustrates a control circuit for activating an electric file using an electric file detector.

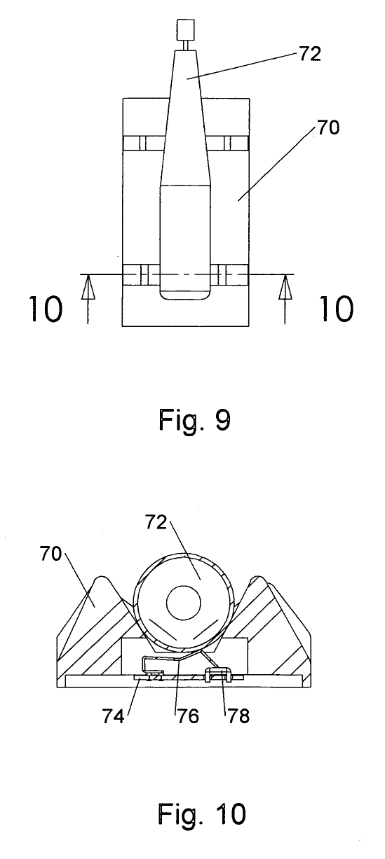

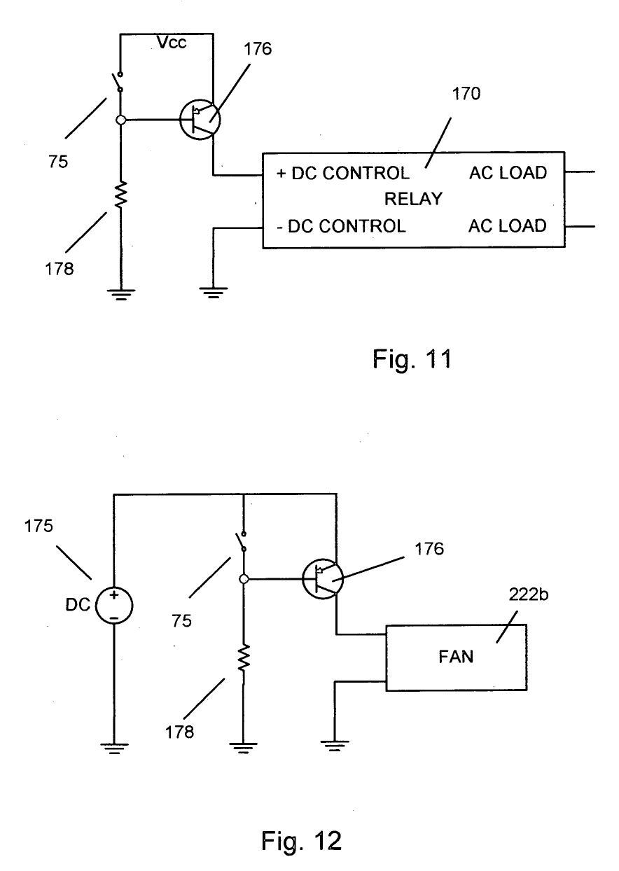

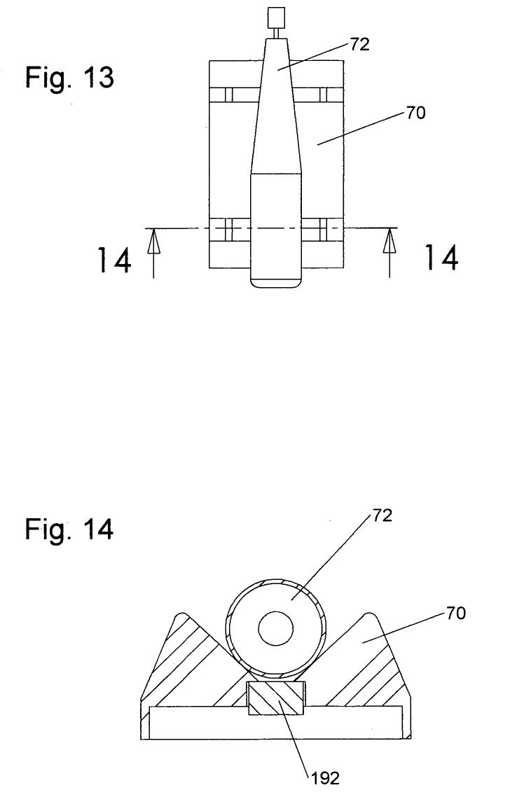

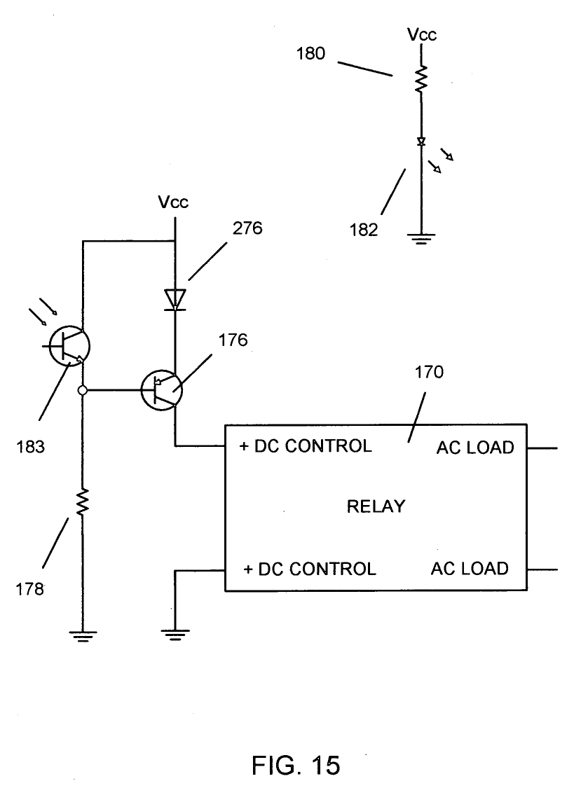

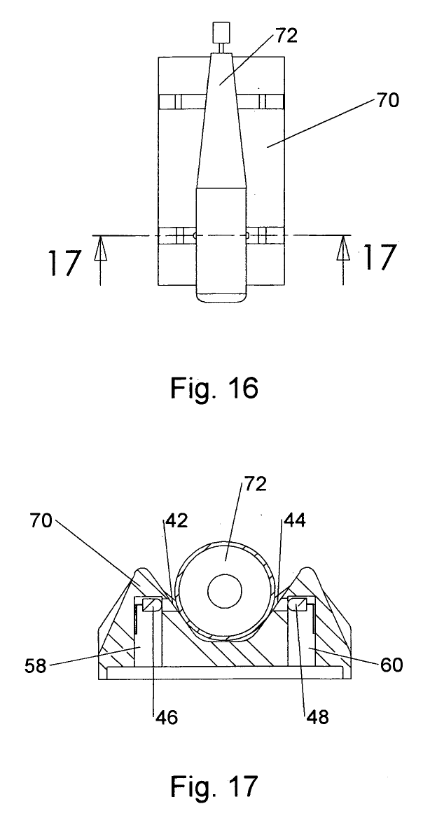

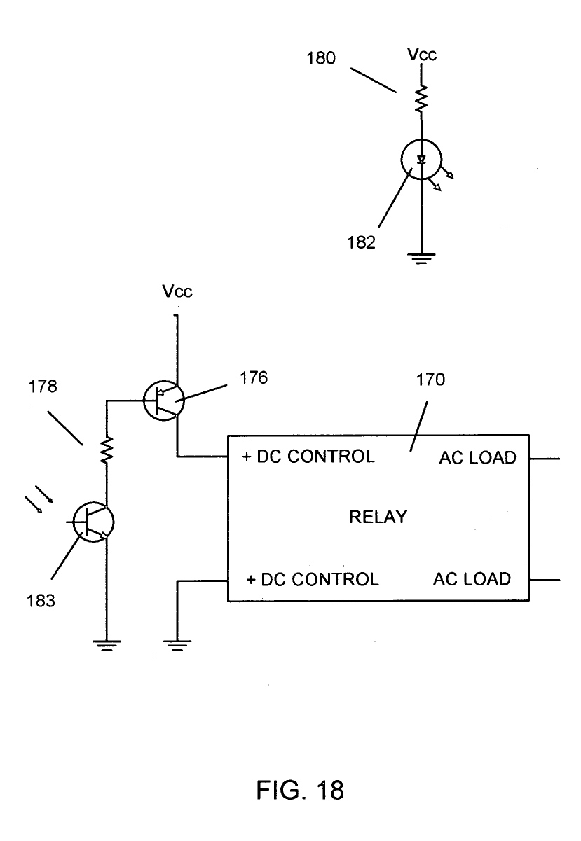

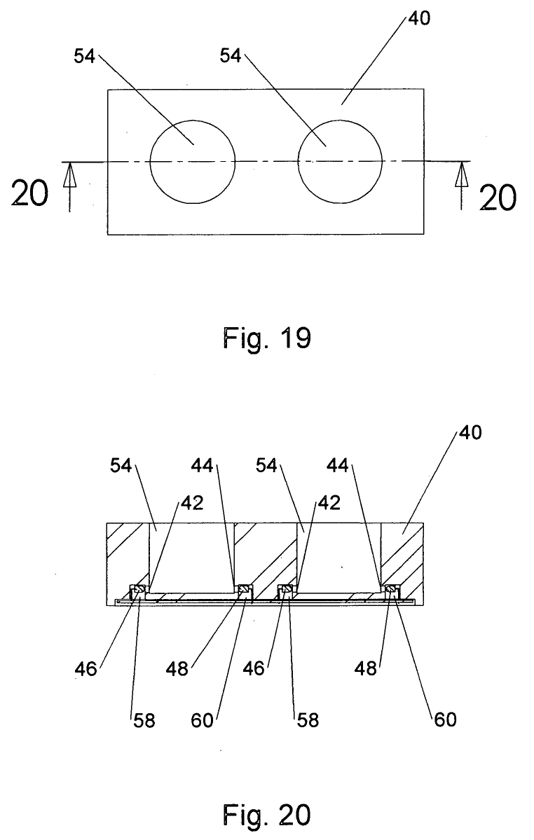

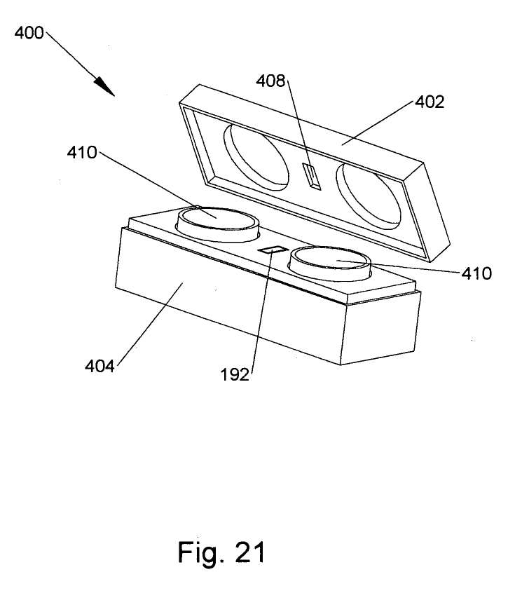

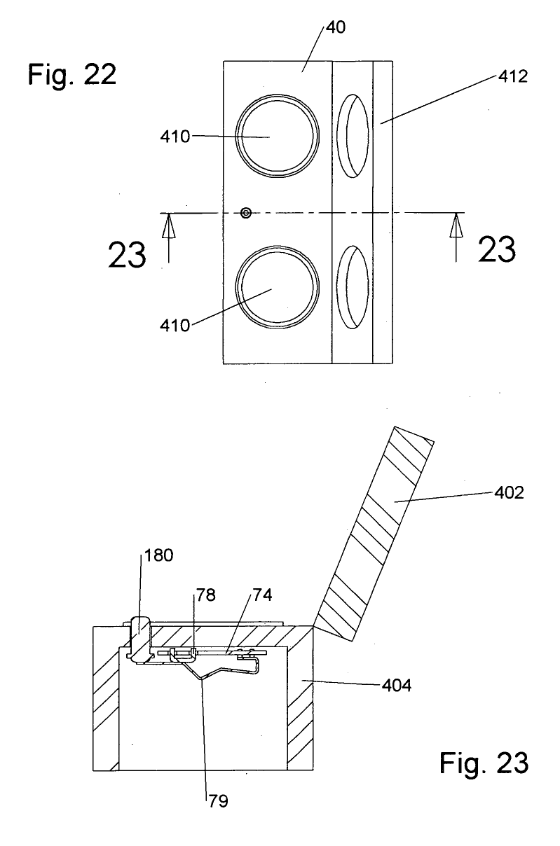

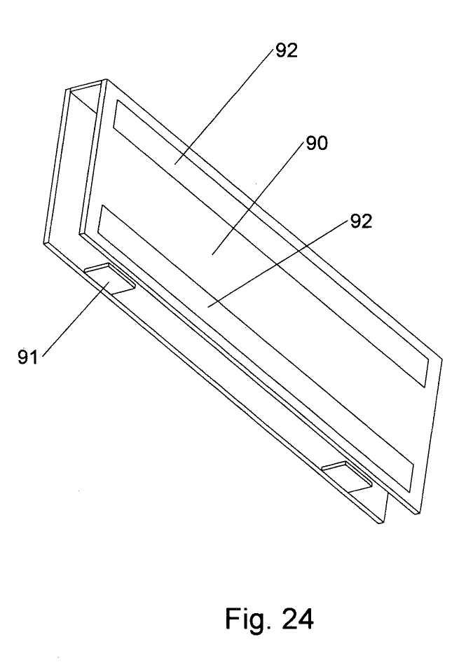

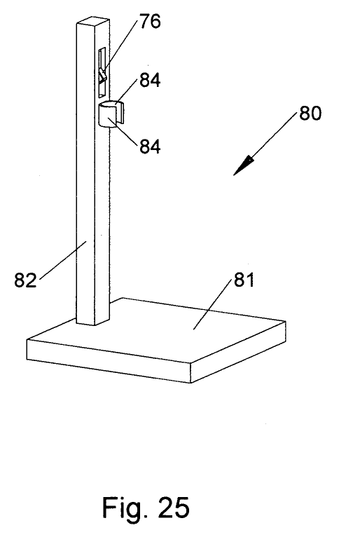

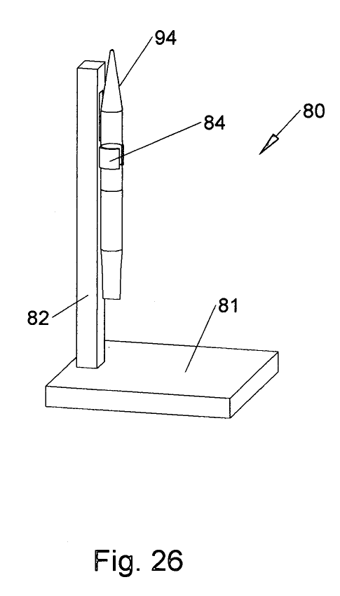

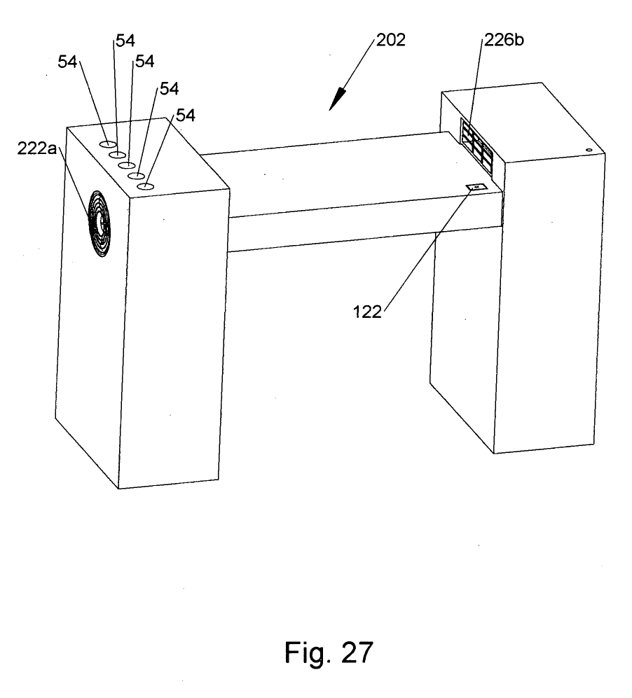

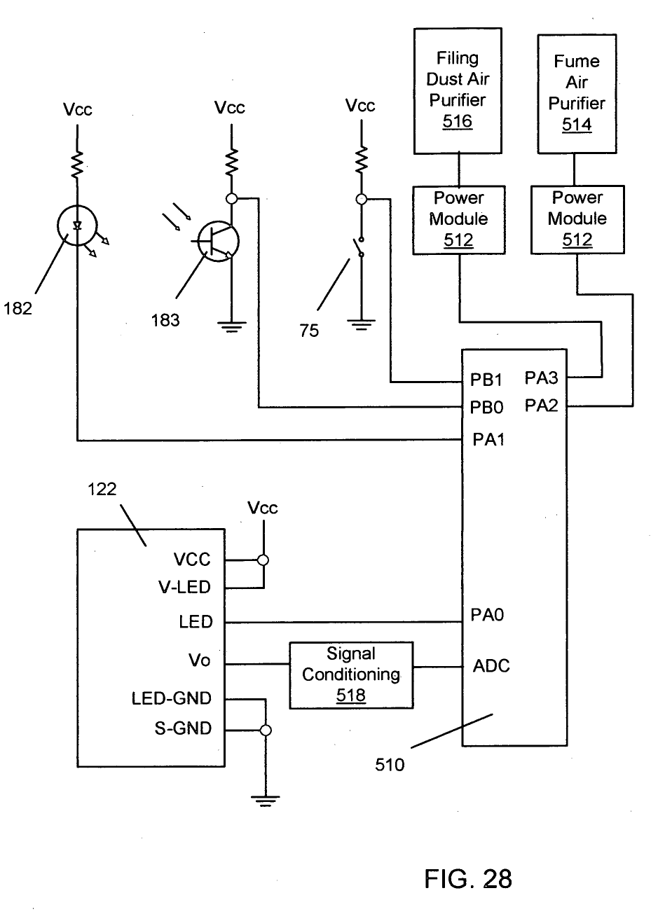

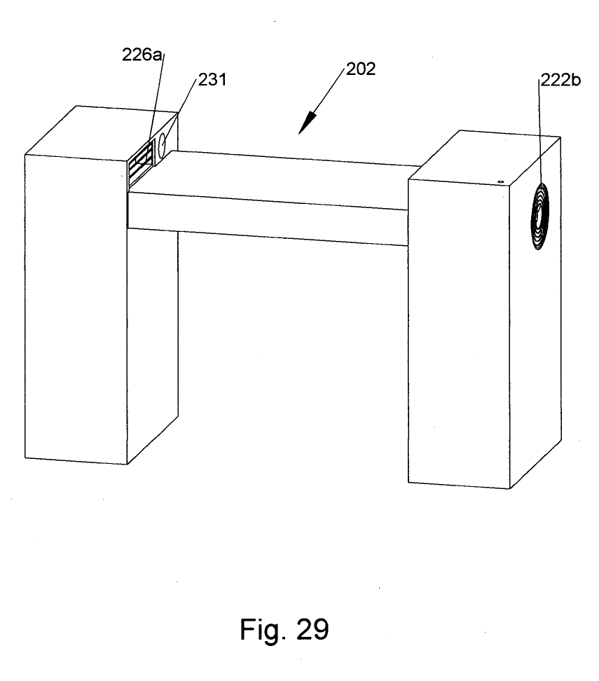

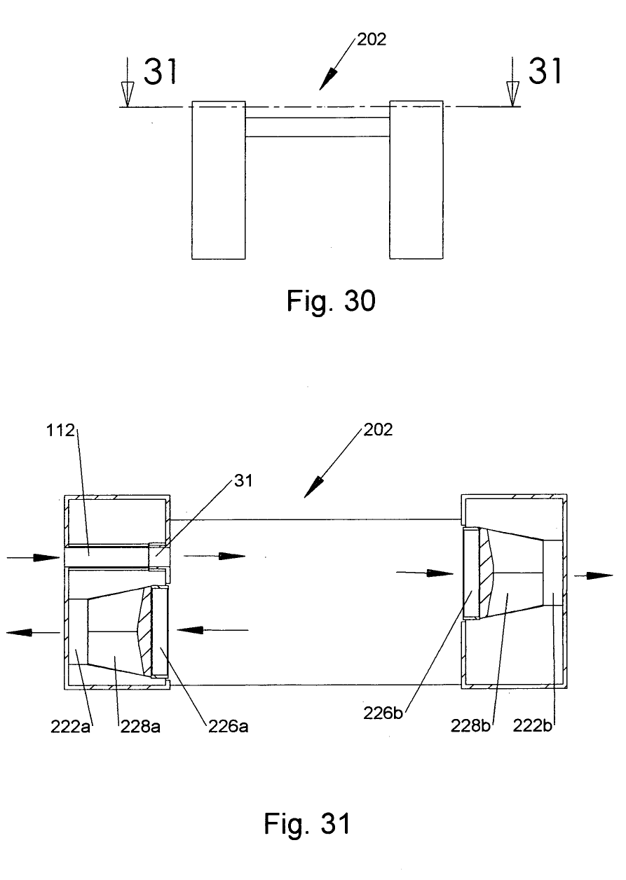

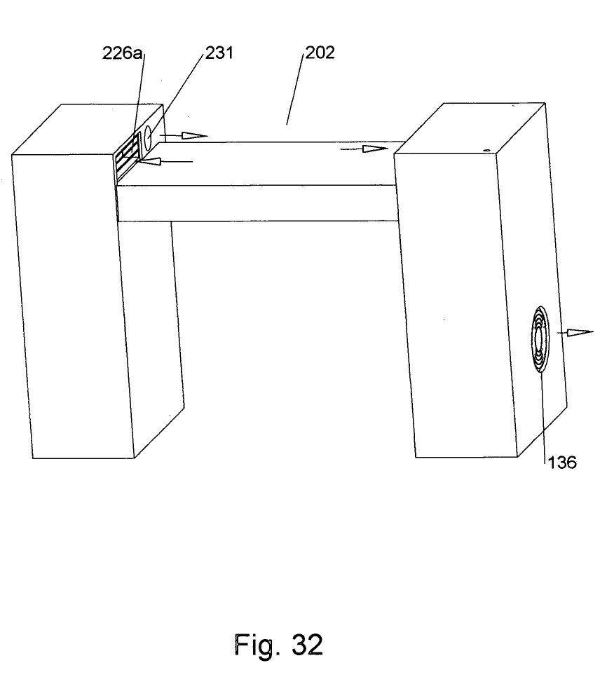

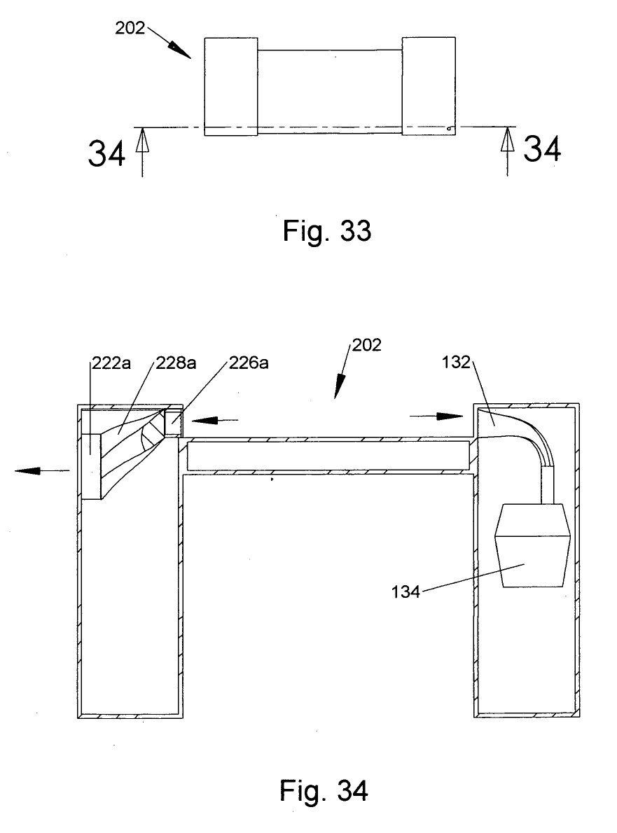

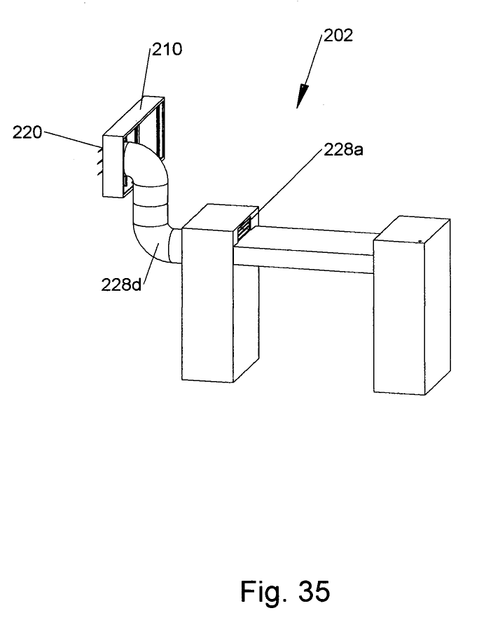

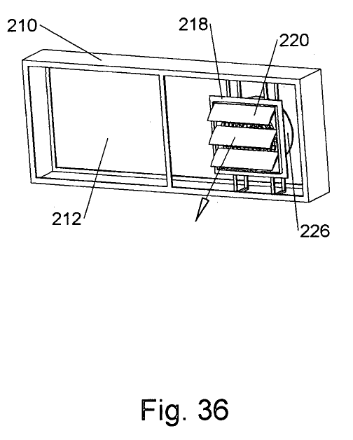

FIG. 8 is a schematic that illustrates a control circuit for activating the fan using the electric file detector.

FIG. 9 is a top view of an electric file detector with the section line 10-10 defines the cutting plane to generate FIG. 10.

FIG. 10 is a section view of the electric file detector with an electric file placed on top.

FIG. 11 is a schematic that illustrates a control circuit to activate electric power using the electric file detector.

FIG. 12 is a schematic that illustrates a control circuit to activate a DC fan using the electric file detector.

FIG. 13 is a top view of another embodiment of the electric file detector having the electric file placed on top with the section line 14-14 defining the cutting plane to generate FIG. 14.

FIG. 14 is a section view of the electric file detector having the electric file placed on top.

FIG. 15 is a schematic that illustrates a control circuit for the electric file detector using a reflective object sensor.

FIG. 16 is a top view of the electric file detector having the electric file placed on top with the section line 17-17 defining the cutting plane to generate FIG. 17.

FIG. 17 is a section view of the electric file detector having the electric file placed on top.

FIG. 18 is a schematic that illustrates a control circuit for using the electric file detector to activate the fan using the interruption of optical signal.

FIG. 19 is a top view of the material container holder with the section line 20-20 defines the cutting plane to generate FIG. 20.

FIG. 20 is a section view of the material container holder.

FIG. 21 is a perspective view of another embodiment of the material container holder.

FIG. 22 is a top view of another embodiment of the material container holder with the section line 23-23 defines the cutting plane to generate FIG. 23.

FIG. 23 is a section view of another embodiment of the material container holder.

FIG. 24 is a perspective view of the snap-on brush detector.

FIG. 25 is a perspective view of another embodiment of a brush holder.

FIG. 25 is a perspective view of another embodiment of a brush holder.

FIG. 26 is a perspective view of another embodiment of the brush holder the brush 94 inserted

FIG. 27 is a perspective view of another embodiment of the air purification station.

FIG. 28 is a schematic that illustrates a control circuit using a microcontroller.

FIG. 29 is the perspective view of another embodiment of the air purification station.

FIG. 30 is a top view of the another embodiment of the air purification system with the section line 31-31 defines the cutting plane to generate FIG. 31.

FIG. 31 is a section view of the another embodiment of the air purification system

FIG. 32 is a perspective view of another embodiment of the air purification system.

FIG. 33 is a top view of the another embodiment of the air purifying station with the section line 34-34 defines the cutting plane to generate FIG. 34.

FIG. 34 is a section view of the another embodiment of the air purification system.

FIG. 35 illustrates the perspective view of another embodiment of the air purification system.

FIG. 36 shows the perspective front view of the shutter box.

For purposes of clarity and brevity, like elements and components will bear the same designations and numbering in each of the figures, even though some of their attributes may be redefined for functioning in the new figure.

### DETAILED DESCRIPTION OF THE INVENTION

As used in this description and in the appended claims, the following words have meanings defined below. Service item means a tool, an equipment such as brush or electric file . . . or material such as isopropanol, acetone, acrylic primer, monomer . . . used in a salon service. Air purifier refers to a device used to control or more specifically to capture or ventilate airborne contaminants, which can be an air filter, a ventilation system or a vacuum cleaner so that, for example, a fume filter can be referred to generally as fume air purifier. Control airborne contaminant such as fumes or filing dust means capture, ventilate, reduce or eliminate that airborne contaminant.

This invention relates to a method for independently controlling fumes and air-borne particles emitted during the artificial nail filing, activating the air purifier only when the contaminants are being emitted, and an apparatus for implementing that method.

The method for salon air purifying comprises the following steps: (a) categorizing contaminants emitted in the salon; (b) selecting air purifiers such that each air purifier most effectively captures a specific category of contaminants; (c) detecting which category of contaminants is being emitted; (d) activating the air purifier that would most effectively capture the specific contaminants being emitted and deactivate other air purifier(s) if not needed.

Step (a), for the artificial nail service, there are two different categories of contaminants emitted during two types of operations. The operations such as polish removal and acrylic application use chemicals such as acetone, alcohol, nail polish remover, primer and monomer, and emit the fumes that are in the gaseous state with particles having the size of tenths of micron. The filing operation that files the artificial nails to the desired shape emits the filing dust having the size up to hundreds of microns.

Step (b), based on the previous analysis, to control those two categories of contaminants, two different types of air purifiers are needed: a fine filter in the range of tenth of micron is used to capture fumes in the gaseous state and a coarse filter or a vacuum cleaner is used to capture the dust.

Step (c), the category of contaminants being emitted is detected directly with sensors, or indirectly from the knowledge of which operation is being performed. The operation is detected by sensing the access to the service items, meaning the tools or materials, used for that operation. Fumes emitting operations such as polish removal and the acrylic application operations are detected by sensing the opening and closing of the material container lids or the removal and replacement of the containers themselves. The acrylic application operation can also be detected by the removal and replacement of the brush used to apply the acrylic mixture to the nails. The filing operation that files the artificial nails to the desired shape is detected by the removal and replacement of the electric file used to file the artificial nails.

Step (d), the information on which category of contaminants being emitted is used to activate the air purifier that would most effectively control the specific contaminants emitted by that operation, and deactivate other air purifier. For operations that generate fumes, the fine filter is activated, and for operations that generate filing dust, the coarse filter is activated,

The above method is implemented in various embodiments of the present invention, in which two separate air purifiers are used, one to capture fumes, and the other to capture filing dust. These two air purifiers are activated by a microcontroller 510 based on the sources of the contaminants or the presence of the contaminants themselves. They can also be activated or deactivated manually by the operator. In case there is only one category of contaminants i.e. one air purifier is used, the various embodiments of the apparatus are used to turn the air purifier on only when the contaminants are being emitted to improve energy efficiency and prolong equipment life.

For simplicity, parts of the air purification system that are not pertinent to the current invention or have been described in the previous embodiments will not be shown or discussed.

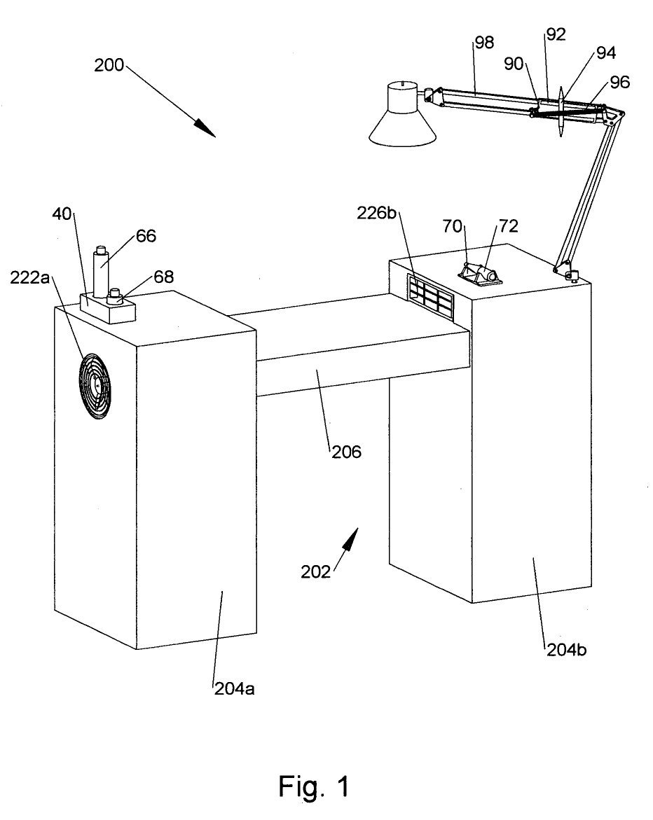

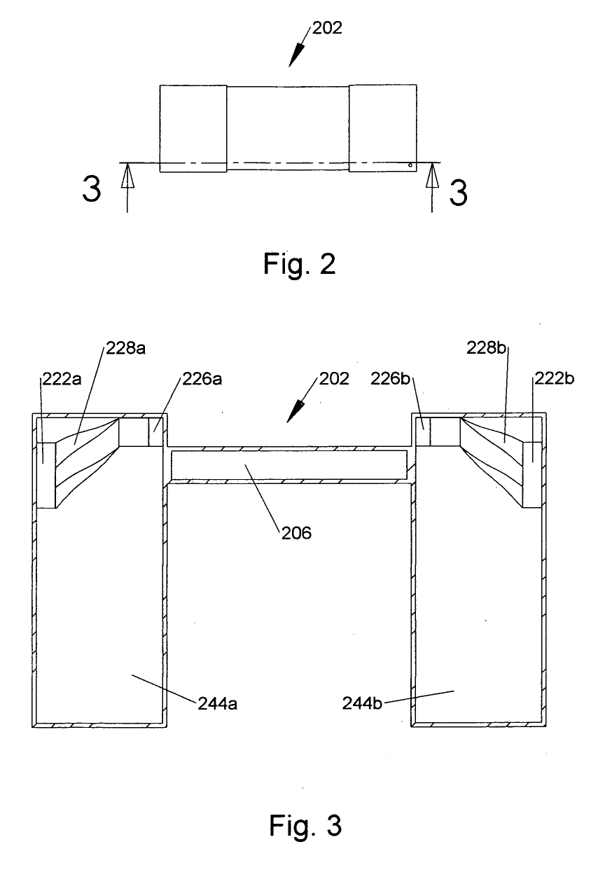

FIGS. 1 through 36 illustrate the mechanical elements that implements the analysis and selection of steps (a) and (b) of the method previously described to execute steps (c) and (d). The first embodiment of the invention is described in FIG. 1. FIGS. 2 through 36 illustrate the embodiments of the service item detectors, air purifiers, ventilation system and air purifying station that can be combined in different ways to create various embodiments of the invention.

FIG. 1 is the perspective view of an air purification system indicated generally at 200 showing an air purifier 204a and an air purifier 204b, both of them support a horizontal work platform 206 so that the whole structure forms a table or more specifically an air purification station 202. On the right side of the work platform 206 is a filter cartridge B 226b. On the left side of the air purifier 204a shows a fan A 222a. On the left top of the nail station 202 is a material container holder 40 with a material container A 66a and a material container B 66b inserted. On the right top of the station is an electric file detector 70 with an electric file 72 placed on top. A light fixture 98 is plugged into the right side of the station. A brush detector 90 is snapped on to a light fixture 98 with a brush 94 inserted between the brush detector 90 and the light fixture spring 96.

FIG. 2 is the top view of the air purification system with the section line 3-3 defines the cutting plane to generate FIG. 3.

FIG. 3 is the section view of the air purification system showing the fan A 222a communicated to a filter cartridge A 226a through an air duct A 228a, the fan B 222b communicated to a filter cartridge B 226b through an air duct B 228b. When the fan A 222a operates, a vacuum is created in the air duct A 228a and air is sucked through the filter cartridge A 226a. This sucked and cleaned air is conducted through the air duct A 228a and is delivered through the fan A 222a to the room. The airflow directions are indicated by the arrows. The fan B 222b, air duct B 228b and filter cartridge B 226b operate in the same principles.

For the ease of interchangeability, the filter cartridge A 226a and filter cartridge B 226b are of the same dimensions and can be inserted into the same opening. Either one can be fume filter cartridge or filing dust filter cartridge, with the differences being the filter materials and porosities.

The filing dust and debris sprayed from the artificial nails in the direction defined by the rotational direction of the electric file 72, so to maximize the filing dust filter effectiveness, it should be located in or near the path of the filing dust particles, not in the opposite direction. After locating the filing dust filter, the other one is installed as the fume filter.

The fume filter cartridge is preferably loaded with foam plastic air filter materials, having plural layers of varying porosity, a coarse filter layer, a fine filter layer and a fume absorbing layer (such as charcoal or activated coal material). The filing dust filter cartridge is preferably loaded with coarse foam plastic air filter materials.

For ease of interchangeability, the fume filter cartridge A 226 and the filing dust filter cartridge A 226 are of the same dimensions, with the difference being the filter materials and porosities. The same principles apply to the fans: they have the same dimensions.

Throughout the document, the fume filter is defined as comprising the fan A 222a communicated to a filter cartridge A 226a through an air duct A 228a with the filter cartridge A 226a being a fume filter cartridge. The filing dust filter is defined as comprising the fan B 222b communicated to a filter cartridge B 226b through an air duct B 228b with the filter cartridge B 226b being a filing dust filter cartridge.

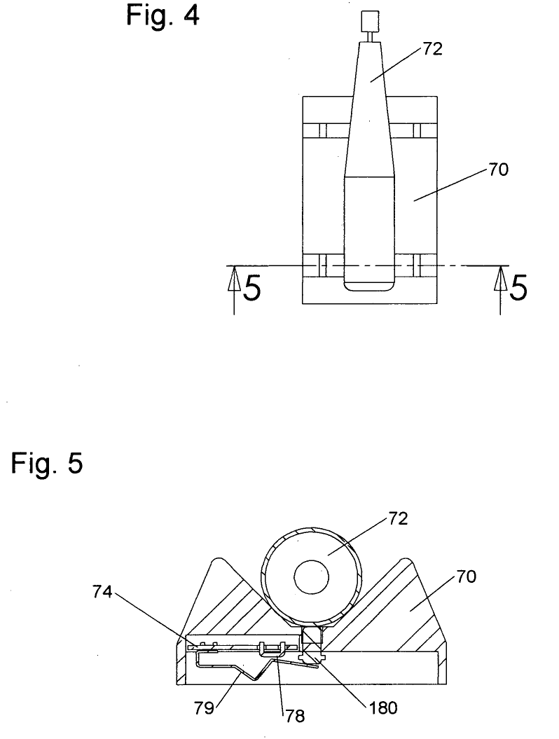

FIG. 4 is the top view of the electric file detector 70 with the section line 5-5 defines the cutting plane to generate FIG. 5.

FIG. 5 is the section view of the electric file detector 70 with the electric file 72 placed on top showing a switch board 74 on which mounted a switch contact C 79 being forced down by a pin 180 to be separated from a switch contact B 78. The switch board 74 is fabricated from printed circuit board material such as FR-4 or any suitable material. The switch contact C 79 and switch contact B 78 are fabricated from conductive materials. The switch contact C 79 is made of spring material such as stainless spring steel or any suitable material so that when the electric file 72 is removed, it return to the original position of making contact with the switch contact B 278. The pin 180 is made of nonconductive material.

When the electric file 72 is placed on an electric file detector 70, its weight presses the pin 180 down, which in turn press the switch contact C 79 down to touch the switch contact B 278, making an open circuit. This open circuit indicates the presence of the electric file 72 on the electric file detector 70. When the operation begins, the electric file 72 is removed from the electric file detector 70, the circuit is closed which indicates the filing is in progress.

FIG. 6 is a schematic that illustrates the use of the electric file detector 70 showing a N.C. switch 75, a normally closed switch, an electrical representation of the combination of the mechanical elements: the switch board 74, the switch contact C 79 and the switch contact B 78. When the N.C. switch 75 is designed to handle the current and voltage level requirements of the fan B 222b, the N.C. switch 75 is used to turn on the fan B 222b directly. In the schematic, one output pin of a power source 172 is connected to the fan B 222b, the other output pin is connected to switch contact C 79. The switch contact B 278 is connected to the fan B 222b. When the electric file 72 is removed from the electric file detector 70, the circuit is closed which turn on the fan B 222b.

FIG. 7 is a schematic that illustrates a control circuit for using the electric file detector 70 to activate and deactivate the electric file 72. When the electric file 72 is removed from the electric file detector 70, the circuit is closed which turn on the electric file 72 the same way as previously described in FIG. 6 and its explanation. In principle, any mechanism used to activate the filing dust air purifier 516 can also be used to activate the electric file 72, or any device since the purpose of such mechanism is to activate the electric power (AC or DC).

FIG. 8 is a schematic that illustrates a control circuit for the electric file detector 70 when the current and voltage level requirements of the fan B 222b is the more than the N.C. switch 75 can handle. One pin of the N.C. switch 75 is connected to Vcc, the other is connected to a pin +DC CONTROL of a relay 170 −DC CONTROL pin of the relay 170 is connected to ground. One AC LOAD pin is connected to an AC power source 174, the other AC LOAD pin is connected to the fan B 222b. When the N.C. switch 75 is closed, current from Vcc flows to +DC CONTROL pin to activate the relay 170, which turns on the power to the fan B 222b. The relay 170 is a RPF240D25 from Crydom Corporation, which requires 15 mA at 5 VDC for control so Vcc is 5V source capable of providing more than 15 mA. The two AC LOAD pins of the relay 170 act as a switch capable of handling up to 15A at 240 VAC.

FIG. 9 is the top view of the electric file detector 70 with the section line 10-10 defines the cutting plane to generate FIG. 10.

FIG. 10 is the section view of the electric file detector 70 with the electric file 72 placed on top showing a switch board 74 on which mounted a switch contact A 76 being forced down to make contact with a switch contact B 78. FIG. 11 is a schematic that illustrates a control circuit to activate the fan B 222b showing a N.O. switch 75, a normally open switch, as an electrical representation of the combination of the mechanical elements: the switch board 74, the switch contact A 76 and the switch contact B 78. The AC LOAD pins are connected to the AC power source and the fan B 222b the same way as described in FIG. 7 and its explanation. In this embodiment, the fan B 222b is an AC fan. The transistor 176 is PN4250A from Fairchild Semiconductor or any suitable device.

When the electric file 72 is placed on an electric file detector 70, its weight presses the switch contact A 76 down to touch the switch contact B 78, close the N.O. switch 75. This causes the base of the PNP transistor 176 to be connected to collector, turning transistor 176 off. No current flows into the +DC CONTROL pin of the relay 170 so the relay 170 is off. To begin filing, the electric file 72 is removed from the electric file detector 70, the N.O. switch 75 is open which allows current to flow from the base of the PNP transistor 176 to the collector and through the resistor 178 to ground. This turn the PNP transistor 176 on so current can flows from its collector to its emitter to turn the relay 170 on.

FIG. 12 is a schematic that illustrates a control circuit to activate the fan B 222b, which is a DC fan, powered by a DC power source 175. In this embodiment, the transistor 176 is a TIP147, power PNP transistor or any suitable device. The operation is similar to the circuit in FIG. 11. When the electric file 72 is placed on an electric file detector 70, its weight presses the switch contact A 76 down to touch the switch contact B 78, close the N.O. switch 75. This causes the base of the transistor 176 to be connected to collector, turning transistor 176 off. To begin filing, the electric file 72 is removed from the electric file detector 70, the N.O. switch 75 is open, which allows current to flow from the emitter of the transistor 176 to the base and then through the resistor 178 to ground. This turn the transistor 176 on so current can flows from its emitter to its collector to turn on the fan B 222b.

FIG. 13 is a top view of another embodiment of the electric file detector 70 having the electric file 72 placed on top with the section line 14-14 defining the cutting plane to generate FIG. 14.

FIG. 14 is a section view of the electric file detector 70 showing the reflective object sensor 192 embedded in a position under the electric file 72. The reflective object sensor 192 is a QRB1114 from Fairchild Semiconductor, a EE-SF5 from OMRON or any suitable device. The distance between the bottom of the electric file 72, the detecting position, to the top of the reflective object sensor 192 is specified in its datasheet. The optimum distance for QRB1114 is specified as 3.81 mm.

FIG. 15 is a schematic that illustrates a control circuit for the electric file detector 70 showed in FIG. 14. The reflective object sensor 192, part number QRB1114 from Fairchild Semiconductor, part number EE-SF5 from OMRON or any suitable device, consists of a pair of light emitter 46 and light sensor 48 represented in FIG. 14 as a light emitting diode and a phototransistor respectively. The light emitter 46 is powered by Vcc through a current limiting resistor 180 to limit the forward current to a desire level specified in the device datasheet. The resistor 178 is 20,000 ohms or any suitable device. The transistor 176 is PN4250A from Fairchild Semiconductor or any suitable device.

In FIG. 14, the electric file 72 is placed on top of the electric file detector 70 so that the light from the light emitter 46 reflected on the electric file 72 is incident on the light sensor 48, turns on the light sensor 48, which turns the transistor 176 off, this deactivates the relay 170. In case the Vce saturation voltage of the light sensor 48 is greater than the Vbe of the transistor 176, a diode 276 is optionally connected between Vcc and the collector of transistor 176 to lower the base voltage level of transistor 176 so that the light sensor 48 can easily turn the transistor 176. When the filing begin, the electric file 72 is removed from the electric file detector 70, the light from the light emitter 46 is not reflected to the light sensor 48 so it is off, allowing current to flow from Vcc to the diode 276, to the emitter of the transistor 176, to its base, to the resistor 178, and then to ground. The base emitter current turns on the transistor 176, which activates the relay 170.

FIG. 16 is a top view of the electric file detector 70 having the electric file 72 placed on top with the section line 17-17 defining the cutting plane to generate FIG. 17.

FIG. 17 is a section view of the electric file detector 70 showing the light emitter 46 embedded in the light emitter housing 58 communicated with the light emitter aperture 42 342 which is blocked by the electric file 72 so light signal cannot pass from the light emitter 46 out to a light sensor aperture 44 344 to reach a light sensor 48.

FIG. 18 is a schematic that illustrates a control circuit for using the electric file detector 70 in FIG. 17 to activate the fan B 222b by using the interruption of optical signal to detect the position of the electric file 72. The light emitter 46 is a QED122 infrared light emitting diode from Fairchild Semiconductor or any suitable device. The light sensor 48 is a QSD122 infrared light phototransistor from Fairchild Semiconductor or any suitable device. For better detection, the peak emission wavelength of the light emitter 46 and the peak sensitivity wavelength of the light sensor 48 should be closely matched. In this embodiment, they are both at 880 nm.

In FIG. 17, the electric file 72 is placed on top of the electric file detector 70, blocking the light signal from the light emitter 46 from reaching the light sensor 48. The absence of this optical signal turn off the light sensor 48, allowing a resistor 184 to pull the base of the transistor 176 to Vcc, turning the transistor 176 off. This deactivates the relay 170. When the filing begins, the electric file 72 is removed from the electric file detector 70, the light from the light emitter 46 incidents on the light sensor 48 turning it on. The light sensor 48 conducts, allowing current to flow from the emitter of the transistor 176 to its base to the resistor 178, and then to ground. The base emitter current turns on the transistor 176, which activates the relay 170.

FIG. 19 is a top view of the material container holder 40 with the section line 20-20 defines the cutting plane to generate FIG. 20.

FIG. 20 is a section view of the material container holder 40 showing two identical container opening, each comprises a light emitter 46 embedded in a light emitter housing 58 which communicates with the light emitter aperture 42 so that light signal can pass from the light emitter 46a out to a light sensor aperture 44 through the material container opening 54, reaching the light sensor 48 embedded in a light sensor housing 60. The materials in the material containers are used in the services that emit fumes so the fume emission is detected indirectly by the presence or absence of the material containers in their respective openings. When the service begins, the material container 66 is removed from the material container opening 54, optical signal from the light emitter 46 is incident on the light sensor 48, this optical signal is used to activate the fume fume air purifier 514. The circuit and the theory of operation are the same as described in FIG. 16 and its explanation. When the service ends, the material container 66 is inserted back into the material container opening 54, the optical signal from the light emitter 46 is blocked from reaching the light sensor 48, this deactivates the fume fume air purifier 514.

FIG. 21 is a perspective view of another embodiment of the material container holder 40 showing, in the base 404, two identical material containers 410. A reflective object sensor 192 is embedded in the middle of the base 404 where the top of the reflective object sensor 192 leveled with the top part of the base 404. A recess 408 is cut in the middle of the lid 402 at the position right on top of the reflective object sensor 192 to provide the required detecting distance from the top of the reflective object sensor 192 to the lid when it closed. The optimum distance for QRB1114 is specified as 3.81 mm. The circuit and the theory of operation are the same as described in FIG. 18 and its explanation.

When the service begins, the lid 402 is removed from the material container base 404, optical signal from the light emitter 46 is not reflected back to the light sensor 48. The absence of this light signal activates the fume air purifier 514. When the service is done, the lid 402 is placed on top of the material container base 404, allowing optical signal from the light emitter 46 to be reflected on the recess 408 and incident on the light sensor 48. The presence of this light signal deactivates the fume air purifier 514.

FIG. 22 is a top view of another embodiment of the material container holder 40 with the section line 23-23 defines the cutting plane to generate FIG. 23. A base 404 is shown on the left, which contains two identical material containers 410, a pin 180. A lid 402 is shown on the right.

FIG. 23 is a section view of another embodiment of the material container holder 40 showing a lid 402 and a base 404, which contains the same components made up a normally closed switch that operates the same way as the one discussed in FIGS. 5, 6 and 8, so they won't be discussed. When the service begins, the lid 402 is open, the switch is closed which activates the fumes air purifier. When the service ends, the lid 402 is closed, which deactivates the fumes air purifier.

FIG. 24 is a perspective view of the snap-on brush detector 90, showing a plastic base 96 providing the frame that snap-on to the light fixture 98 for holding a membrane switch 92, which is implemented as two parallel strips, a plastic latch 94 for holding the brush detector 90 around a light fixture frame 98. The brush 94 is used to apply acrylic mixture to the finger nails, that step emits harmful fumes so the brush detector 90 is used to detect the removal of the brush 94 to begin that step and to activate the fume air purifier 514 in the following manner. In FIG. 1, the brush detector 90 is snapped on to the light fixture 98 with a brush 94 inserted between the brush detector 90 and the light fixture spring 96. When the brush 94 in inserted between the brush detector 90 and the light fixture spring 96, the brush 94 asserts a force on the membrane switch 92 creating a close circuit, which deactivates the fume air purifier 514. The circuit and the theory of operation are the same as described in FIGS. 11 and 12 and their explanation. The membrane switch 92 is normally open so when the service begins, the brush 94 is removed, the membrane switch 92 opens that activates the fume air purifier 514.

FIG. 25 is a perspective view of another embodiment of a brush holder indicated generally at 80 showing a brush holder base 81, a brush holder pin 80, two brush holder jaws 84, a switch contact A 76 of a normally open switch.

FIG. 26 is a perspective view of another embodiment of the brush holder indicated generally at 80 with the brush 94 inserted between the brush holder jaws 84. The control circuit and the theory of operation are the same as described in FIGS. 11, 12 and 24 and their explanation. When the brush 94 is inserted between the brush holder jaws 84, it presses the switch contact A 76 down making a closed circuit between the switch contact A 76 and the switch contact B 78 (not shown) that deactivates the fume air purifier 514. When the service begins, the brush 94 is removed from the brush holder jaws 84, the circuit between the switch contact A 76 and the switch contact B 78 is open that activates the fume air purifier 514.

FIG. 27 is a perspective view of another embodiment of the air purification station 202 showing five material container openings 54, a dust sensor 122, the fan A 222a, and a filter cartridge B 226b.

The material container openings 54 in this embodiment use the same operating principles as the material container holder 40 which detects the presence or absence of the material container using optical signals previously described in FIGS. 15 and 20 and their explanations. The dust sensor 122, part number GP2Y1010AU0F from Sharp Corporation, is used to detect the presence of the filing dust.

FIG. 28 is a schematic that illustrates a control circuit using the microcontroller 510 to detect the status of the light sensor 48, switch 73, and dust sensor 122, to activate and deactivate the fume air purifier 514 and the filing dust air purifier 516. The microcontroller 510 is a PIC18FXX2 from Microchip Corporation or any suitable device. The PIC18FXX2 has an ADC (Analog to Digital Converter) and output ports capable of sinking and sourcing 20 mA. PA0, PA1, PA2, and PA3 pins of the microcontroller 510 are output pins. PB0 and PB1 pins of the microcontroller 510 are input pins. A signal-conditioning module 518 (optional) is used to filter and convert the output signal of the dust sensor 122 to the voltage and current suitable to drive the ADC. The interface to the microcontroller 510 is the same for all the mechanical electrical switches whether they are normally open or normally closed since the logic is programmed in the control firmware. The interface to the microcontroller 510 is also the same for the reflective object sensor 192 and optical interruption detection method using the light emitter 46 and light sensor 48.

The microcontroller 510 generates a pulse at pin PA0 every 10 ms, with a pulse width of 0.32 ms as specified in the component datasheet, to drive the pin LED of the dust sensor 122. During the time the dust sensor 122 pin LED is on, the ADC reads Vo, the output of the dust sensor 122. When the dust sensor 122 reports a dust level above a preset level defined by the operator, the filing dust air purifier 516 is activated until the filing dust level goes below the preset level.

The microcontroller 510 also generates pulses to drive the light emitter 46 and others. These pulses have arbitrary timing. The microcontroller 510 checks the light sensor 48 output level when the light emitter 46 is off and also when it is on to ensure the light sensor 48 output is a result of the correspondent light emitter 182. When the light sensor 48 or the switch 75 reports the fume emission, the microcontroller 510 activates the fume air purifier 514 via the power module 512. The power module 512 converts the microcontroller 512 signaling voltage to the voltage and current capable of driving the air purifiers. The power module 512 consists essentially of a relay 170 or a power transistor and supporting components as previously discussed in FIGS. 8, 11, 12, 15 and 18 and their explanation.

FIGS. 29, 30 and 31 illustrate another embodiment of the air purification station 202. The arrows in the following indicate the airflow directions. FIG. 29 is the perspective view of another embodiment of the air purification station showing the filter cartridge A 226a is loaded with fume filter, a filling dust fan 231 to assist in delivering the filling dust to the vacuum cleaner adapter 132, the filling dust is then sucked in by the vacuum cleaner 134.

FIG. 30 is the top view of the another embodiment of the air purification system with the section line 31-31 defines the cutting plane to generate FIG. 31.

FIG. 31 is the section view of the another embodiment of the air purification system showing the fan A 222a, the air duct A 228a, the filter cartridge A 226a loaded with fume filter, a dust fan 231 to assist in delivering the filling dust to the filter cartridge B 226b loaded with the filling dust filter.

The fan B 222b creates a vacuum in the air duct B 228b and air is sucked through the filter cartridge B 226b. This sucked and cleaned air is conducted through the air duct B 228b and is delivered through the fan B 222b to the room. In this embodiment, the dust fan 231 blows the filling dust particles toward the filling dust filter, enhancing the filling dust filter ability to attract filing dust.

FIGS. 32, 33 and 34 illustrate another embodiment of the air purification station 202. FIG. 32 is a perspective view of another embodiment of the air purification station 202 showing the filter cartridge A 226a, a dust fan 231 and the exhaust opening grill.

FIG. 33 is a top view of the another embodiment of the air purification station 202 with the section line 34-34 defines the cutting plane to generate FIG. 34.

FIG. 34 is a section view of the another embodiment of the air purification system showing the fan A 222a, the air duct C 228c, the filter cartridge A 226a loaded with fume filter, a filling dust fan 231 to assist in delivering the filling dust to the vacuum cleaner adapter 132, the filling dust is then sucked in by the vacuum cleaner 134.

FIG. 35 illustrates the perspective view of another embodiment of the air purification system showing a shutter box 210 mounted on a wall opening or an overhung window (not shown), an opening of an air duct A 228a, an air duct D 228d.

FIG. 36 shows the perspective front view of the shutter box 210 includes a substantially rectangular shaped window frame having a window panel 212, a shutter 218, flaps 220, the fan A 222a secured by fan supports 224.

When the fan A 222a operates, a vacuum is created in the air duct A 228a and air is sucked through the air duct A 228a opening. This sucked air is conducted through the air duct A 228a and is expelled through the fan A 222a. The velocity pressure from fan A 222a blows the flaps 220 open to let the air out.

In the above embodiments, a nail station is used as a convenient packaging for the air purification system, however this should not limit the invention to this particular packaging. The air purification system can be packaged in a box or two separate boxes one for the fume filter and one for the filing dust filter.

Other embodiments of the current invention can also use any combination of the above technologies: electrical switch, membrane switch, optical detection or different technologies such as capacitive or electric field detection, or any technology available to detect the access to the materials or the tools used such as the brush or the electric file.

This invention provides a breadth of scope that includes all methods of independently filtering the different types of contaminants in salons using different detectors, sensors, or manual operation. Any variations in methodology not described herein would be considered under the scope of this invention.

The foregoing description, for purposes of explanation, used specific nomenclature to facilitate a thorough understanding of the invention. However, it will be apparent to one skilled in the art that specific details are not required in order to use the invention. Thus, the foregoing descriptions of specific embodiments of the invention are presented for the purposes of illustration and description. They are not intended to be exhaustive or to limit the invention to the precise forms and particular component selections shown here. Many modifications and variations are possible in view of the above descriptions by combining different embodiments of the elements. The embodiments was chosen and described in order to best explain the principles of the invention and its practical applications, thereby enabling others skilled in the art to best utilize the invention and its various embodiments with selected modifications in different combinations as suited to the particular use contemplated.

I claim:

1. Method for independently controlling different categories of airborne contaminants in a salon, which comprises:
(a) categorizing contaminants emitted in the salon based on the air purification effectiveness;
(b) selecting a plurality of air purifiers such that each air purifier is most effective in capturing a specific category of contaminants;
(c) detecting which category of contaminants is emitted;
(d) activating the air purifier most effectively controls the category of contaminants being emitted; and
(e) deactivating said air purifier when the emission stops.

2. Method for detecting the emission of a contaminant during a salon service, which comprises:
(a) defining which service item is used when offering a service that emits said contaminant.
(b) detecting the use of said service item that indicates said service is performed thus said contaminant is emitted.

3. An apparatus for independently controlling different categories of airborne contaminants in salon comprising:
(a) at least one fumes air purifier to control fumes;
(b) at least one filing dust air purifier to control filing dust;
(c) means for detecting the fume emission;
(d) means for activating the fumes air purifier while fumes are emitted,
(e) means for detecting the emission of filing dust; and
(f) means for activating the filing dust air purifier while filing dust are emitted,

4. The nail salon air purification system according to claim 3 wherein the means for detecting fume emission comprises:
a brush detector, implemented with one of the technology selected from a list: mechanical electrical switch, optical sensing, electric field sensing, and capacitive sensing, for detecting the removal and replacement of the brush to use to apply acrylic mixture to the nails; and
a material container detector, implemented with one of the technology selected from a list: mechanical electrical switch, optical sensing, electric field sensing, and capacitive sensing, for detecting the removal and replacement of the material container, thus the access to any of the materials that emit fumes, except those materials used with the brush.

5. The nail salon air purification system according to claim 3 wherein the means for detecting that fumes are emitted comprises a material container detector for detecting the access to any of the materials that emits fumes.

6. The nail salon air purification system according to claim 3 wherein the means for detecting the filing dust is emission comprises at least one electric file detector to detect the use of an electric file.

7. Apparatus for detecting the emission of a contaminant during a service offered in a salon via the use of a service item in offering said service, which comprises:
(a) means for establishing a frame of reference to define the service item usage status; and
(b) means for detecting the use of said service item in the salon service where such use indicates the service is performed and thus the contaminant is emitted.

8. The apparatus for detecting the emission of a contaminant according to claim 7, wherein the means for establishing a frame of reference is a material container detector; and
means for detecting the use of said service item is implemented with one of the technology selected from a list: mechanical electrical switch, optical sensing, electric field sensing, and capacitive sensing, for detecting the removal and replacement of the material container, thus the access to any of the materials that emit fumes.

9. Apparatus for activating electric power during a salon service via the use of a service item in offering said service, which comprises:
(a) a power module to turn on and off the electric power;
(b) means for detecting the use of said service item in the salon service where such use indicates the service is performed; and
(c) means for activating said power module when the detecting means indicates that said service item is used and for deactivating the power module when the service item is not used.

10. The apparatus for activating electric power according to claim 9, wherein an electric file is connected to the electric power.

11. The apparatus for activating electric power according to claim 8, wherein a filing dust air purifier is connected to the electric power.

12. An air purification nail station, which comprises:
(a) a horizontal work platform;
(b) an independently operated fume air purifier to control fumes emitted during a salon service, said fumes air purifier is attachable to one end of the work platform to support said platform, and air inlet to the fume air purifier is located above the work platform to suck in fume laden air; and
(c) an independently operated filing dust air purifier to control filing dust emitted during the filing of artificial nails to desired shape, said filing dust air purifier is attachable to the opposite end of the work platform to support the platform so that together with the fumes air purifier support the whole structure forms a nail station, and air inlet to the filing dust air purifier is located above the work platform to suck in filing dust laden air.
